(19) United States
(12) Patent Application Publication
(10) Pub. No.: US 2005/0078191 A1
(43) Pub. Date: Apr. 14, 2005

(54) System and method to allow undoing of certain digital image modifications

(75) Inventor: Amy E. Battles, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY LP, Houston, TX (US)

(21) Appl. No.: 10/686,081

(22) Filed: Oct. 14, 2003

(51) Int. Cl. H04N 5/225

(52) U.S. Cl. 348/207.99

(57) ABSTRACT

When a digital imaging system, such as a digital camera or scanner system, performs an image adjustment that affects pixels in a digital photograph, the system stores the original pixel data in a header, tag, or similar informational portion in the resulting digital image file, The original pixel data can be retrieved at a later time and replaced in the digital photograph as a way to “undo” the image adjustment. The digital imaging system may optionally be a digital camera. The digital imaging system may optionally be a scanner system. The pixel data retrieval may be performed by the digital imaging system or by another device, such as a computer.

A portion of the disclosure of this patent document contains material which is a subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to digital imaging.

### BACKGROUND OF THE INVENTION

Many digital imaging systems provide automatic adjustment or correction of the digital photographs they take. For example, many digital cameras provide an “automatic exposure” function that automatically adjusts the tone of a digital photograph in a way that is likely to provide a pleasing image. Some cameras automatically determine the characteristics of the illuminant providing light to the scene being photographed, and adjust the resulting photograph so that its colors appear more nearly like the photographer's likely perception of the scene. Some cameras may provide for the detection and correction of “redeye” in photographs. Redeye results when light from the camera's flash reflects from the eyes of people in the scene, causing the eyes in the resulting photograph to have an unnatural red glow.

Such automatic features can significantly improve the ease of use of digital cameras, and usually improve the quality of the photographs a camera takes. However, sometimes these automatic features can give unexpected or incorrect results. For example, an unusually-colored photographic subject might confuse the camera's illuminant detection feature, causing the camera to distort the color of the resulting digital photograph rather than improve it. Or a naturally-occurring feature in a scene, for example, a red polka-dot shirt, might appear to the camera to be redeye, causing the camera to incorrectly change some red areas of the photograph to a dark color.

When these failures of automation occur, the camera user typically has little recourse. Cameras save only the adjusted version of a digital photograph, and any information about the unadjusted state of the photograph is lost, If the photographer notices the problem at the time the photograph is taken, it may be possible to readjust the camera settings and take another photograph, but this is often not possible. The photographic opportunity may be lost, or the photographer may fail to notice the problem for any of a number of reasons. For example, the digital camera may not have a display for reviewing the photographs as they are taken.

Similar difficulties can also occur in an automated scanning system. For example, a scanner with an automatic photo feeder can scan many photographs in sequence without operator intervention, and can perform automatic image adjustments. These automatic adjustment can sometimes fail, resulting in a digital image file of poorer quality than if the adjustment had not been performed at all.

What is needed is a way to undo at least some image adjustments performed automatically by a digital imaging system,

### SUMMARY OF THE INVENTION

When a digital imaging system, such as a digital camera or scanner system, performs an image adjustment that affects pixels in a digital photograph, the system stores the original pixel data in a header, tag, or similar informational portion in the resulting digital image file. The original pixel data can be retrieved at a later time and replaced in the digital photograph as a way to “undo” the image adjustment. The digital imaging system may optionally be a digital camera. The digital imaging system may optionally be a scanner system. The pixel data retrieval may be performed by the digital imaging system or by another device, such as a computer.

### BRIEF DESCRIPTION OF THE DRAWINGS

FIG. 1 depicts a simplified block diagram of a typical digital camera.

FIG. 2 depicts a digital image array.

FIG. 3 depicts the results of a digital image adjustment.

FIG. 4 illustrates a table of original pixel data.

FIG. 5 shows the general structure of a TIFF file.

FIG. 6 depicts a user control in accordance with an example embodiment of the invention.

FIG. 7 shows a digital camera connected to a computer using an interface cable.

FIG. 8 depicts a typical scanning system.

FIG. 9 depicts a flowchart of a method in accordance with an example embodiment of the invention.

### DETAILED DESCRIPTION OF THE PREFERRED EMBODIMENT

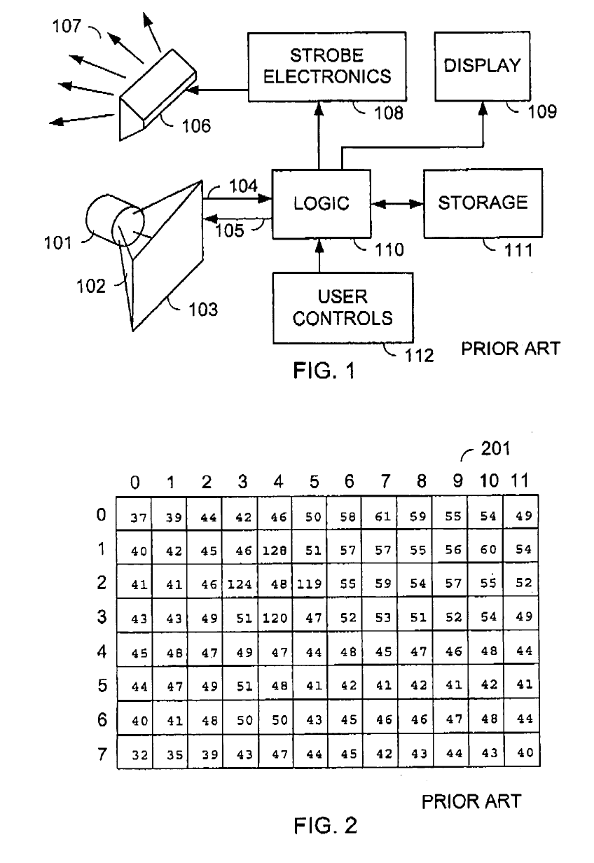

A digital camera serves as an example of a digital imaging system that can embody the invention. FIG. 1 depicts a simplified block diagram of a typical digital camera. A lens 101 gathers light from a scene and redirects it 102 so that an image of the scene is projected onto an electronic array light sensor 103. The electronic array light sensor 103 typically comprises many individual light-sensitive elements called “pixels”. By virtue of the operation of lens 101, each pixel corresponds to a viewing direction and a resulting scene location.

In a typical sensor, each pixel accumulates electrical charge in proportion to the intensity of light falling on the pixel. After a time, the distribution of the charges in the pixels of the electronic array light sensor 103 approximately duplicates the distribution of the light intensity coming from the scene.

The operation of electronic array light sensor 103 is controlled by logic 110. Logic 110 may contain a microprocessor, a digital signal processor, dedicated hardware, or a combination of these. Logic 110 typically provides timing and control signals 105 to electronic array light sensor 103, and receives image information signals 104 from electronic array light sensor 103. Logic 110 measures the image information signals, typically using an analog-to-digital converter, and organizes the resulting numerical values into an ordered array. This ordered array of numerical values, representing scene brightness measurements, is often called a digital image, but may also be called a digital photograph, or simply an image or a photograph.

The digital camera also comprises storage 111. Storage 111 may contain random access memory (RAM), read only memory (ROM), flash memory, or other forms of volatile or nonvolatile memory, including a magnetic or optical disk media. Typically, digital images are temporarily stored in RAM so that they can be processed, and are then placed into nonvolatile memory for longer-term storage. Upon storage in nonvolatile memory, the digital image is typically organized into a standard format that includes header and descriptive information as well as the digital image itself. This combination is often referred to as an image file. Common file formats for digital photographs are the JPEG format, named for its proponent the Joint Photographic Experts Group, and the TIFF (Tagged Image File Format) format.

The digital image may be subjected to image compression before being stored in the file. Image compression refers to any technique for representing the digital image with a reduced amount of numerical data. A file holding a compressed digital image typically also includes information that assists in recovering the uncompressed digital image, either exactly or sufficiently accurately, at a future time.

A typical digital camera also includes user controls 112, by which a user of the camera can, for example, set camera parameters, initiate the taking of pictures, and review digital photographs on a display 109. The camera may also include a strobe 106 that can provide additional light 107 to the scene, under the control of strobe electronics 108 and logic 110.

FIG. 2 depicts a digital image 201. Each element of digital image 201 contains numerical information about the brightness of its corresponding scene location. The array elements are often called “pixels”, because they correspond to the light-sensitive elements of electronic array light sensor 103, which are also called “pixels”. The meaning of the term “pixel” is generally clear from the context of the reference. The numerical values in digital image 201 may be called “pixel data”. For ease of representation, the digital image 201 of FIG. 2 contains only a small number of pixels. A typical digital camera can produce digital image files with many thousands or millions of pixels.

Some digital cameras use selective wavelength filtering on the pixels of an electronic array light sensor 103 to facilitate the taking of color digital photographs. The digital image 201 of FIG. 2 is presented without regard to color information, but one of skill in the art will recognize that the invention can be utilized in a camera with color capability as well as in one without. In the digital image 201 of FIG. 2, each of the pixels, arranged in 8 rows of 12 pixels each, contains pixel data indicating the brightness of the corresponding location in the scene photographed by the camera.

A digital camera in accordance with an example embodiment of the invention performs an image adjustment on the digital image 201. For example, an algorithm may determine that certain pixel data in certain pixels are the result of redeye in the photograph, and may replace the pixel data with other data calculated to remove the redeye effect from the digital image 201.

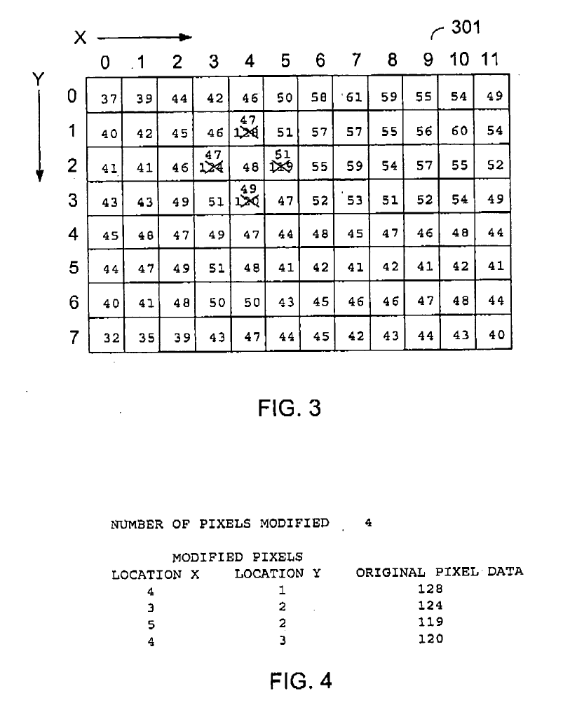

FIG. 3 depicts the results 301 of a digital image adjustment such as redeye removal. In FIG. 3, the pixel data in four pixel locations have been changed. In the process, the camera records the data illustrated in the table in FIG. 4. In the table of FIG. 4, the camera has recorded the number of pixels modified by the image adjustment, their locations (by recording the X and Y coordinates of the modified pixels in digital image 301), and the original pixel data that resided in the locations before the image adjustment. The adjusted digital image 301 of FIG. 3 and the information in the table of FIG. 4 are sufficient to reconstruct the unadjusted digital image 201, should the photographer desire to do so,

However, in a typical digital camera, the information in the table of FIG. 4 is not stored, so that once a digital photograph is stored in an image file, any opportunity to undo image adjustments is lost. Especially when an image adjustment touches only some of the pixels in a digital image, it may be difficult to discern at the time the photograph is taken that there has been a failure of an automatic adjustment. The digital camera may not include a display for reviewing photographs, or the display may be small enough that some unfortunate image effects are not visible. Once the photograph is uploaded to a computer or otherwise viewed in a more revealing way, flaws introduced by the image adjustment may become visible. Unfortunately, with a typical digital camera, the information needed to recover the unadjusted image is lost.

A digital camera in accordance with the present invention provides a mechanism by which a digital image adjustment can be reversed, even after the affected digital photograph has been stored or transmitted to another device.

In a camera in accordance with one example embodiment of the invention, digital photographs are stored in the JPEG image format. The JPEG format, named for its proponent the Joint Photographic Experts Group, is commonly used for storing and exchanging digital photographs. In its most common implementation, the format stores the digital image in a compressed form. Many digital images are stored in a particular kind of JPEG file format, the JPEG File Interchange Format (JFIF). For the purposes of this disclosure, the term “JPEG file” encompasses files stored in the JFIF format.

A JPEG file is a sequence of bytes organized into a number of “segments”. Bach segment begins with a two-byte code beginning with a hexadecimal FF value. The byte immediately following the FF value indicates what type of segment is being defined. For example, a skeletal outline of a JPEG file (with comments that are not part of the file) maybe as follows:

Listing 1. - Skeletal JPEG file structure

| | |
|---|---|
| FF D8 | Start of image |
| FT DB | Define quantization table |
| . | |
| . | |
| . | |
| FF C0 | Start of frame |
| . | |
| . | |
| . | |
| FF C4 | Define Huffman table |
| . | |
| . | |
| . | |
| FF DA | Start of scan |
| . | |
| . | |
| . | |
| FF D9 | End of image |

There are many segment types possible. A particular JPEG file may use many more than are shown in Listing 1, and a particular JPEG file may use many more segments. Some of the segment types, such as “define quantization table” and “define Huffman table” contain information that enables the reading software application or device to reverse the image compression. Some types, such as “start of frame”, may contain information about the size and color depth of the image.

Most segment types contain data in addition to the segment marker. In a segment containing data, the two bytes following the segment marker indicate how many bytes of data that segment contains, including the two length bytes but not including the marker itself. For example, a “start of frame” segment may consist of the bytes (again with comments that are not part of the file):

Listing 2. - Start of frame segment

| FF | C0 | | | Start of frame marker |
|---|---|---|---|---|
| 00 | 11 | | | Length count |
| 08 | 00 | 69 | 00 | Segment data |
| 80 | 03 | 01 | 22 | . |
| 00 | 02 | 11 | 01 | . |
| 03 | 11 | 01 | | . |

In this segment, the length count is a hexadecimal 11, which corresponds to a decimal value of 17. Including the two length bytes, this segment has 17 bytes, so 15 bytes follow the length bytes and contain the relevant segment information. The meaning of the data in the segments is not relevant here.

The JPEG specification also includes a special segment type called a comment, Comment segments begin with the segment marker FF FE, and are generally ignored by software applications or devices reading the file. In one example embodiment of the invention, a digital imaging system such as a camera uses a comment segment in a JPEG file to store information about pixels that have been modified in the digital image by an image adjustment. For example, the information in the table of FIG. 4 may be encoded into a comment segment as follows:

Listing 3. - Example comment segment with undo information

| FF FE | Comment segment marker |
|---|---|
| 00 1A | Length count |
| 98 76 | special code |
| 00 04 | Number of pixels modified |
| 00 04 00 01 80 | First pixel X, Y, data |
| 00 03 00 02 7C | Second pixel |
| 00 05 00 02 77 | Third pixel |
| 00 04 00 03 78 | Fourth pixel |

In this example segment, comment segment, 26 bytes (1A hexadecimal) are included after the segment marker. A special two-byte value immediately following the length bytes indicates that this comment segment contains original pixel data to be used for undoing an image adjustment. In this example segment, a special code of hexadecimal 9876 has been chosen as a code that is unlikely to appear in a typical comment segment. A two-byte value indicates that original pixel data for 4 modified pixels are to be stored. Each of the 4 modified pixels is indicated by X and Y locations in the digital image (two bytes each), and a single byte indicating the original pixel data that was stored in the pixel prior to the image adjustment.

One or more such comment segments may be inserted into appropriate positions in the JPEG file. One of skill in the art will be able to envision other suitable ways to organize the values in the segment, and will recognize that other values for the special code may be used.

A software application or device that is configured to implement the invention will examine any comment segments in the file to see if the special code is present following the length bytes. If the code is found, the software application or device can extract the original pixel data and replace it into the digital image whenever it is requested to do so. Preferably, the replacing of the original pixel data will occur after the image has been uncompressed.

The JPEG specification also provides several “APP markers” that allow file writers to insert application-specific information into JPEG files. For example, a segment beginning with the hexadecimal value FF E3 is said to use the APP3 marker. An APP marker may be used in an embodiment of the invention in place of the comment marker. The other aspects of a segment containing original pixel data may be the same as if a comment marker had been used. A software application or device configured to implement the invention using an APP marker will examine APP segments for a similar special code, and replace the original pixel data into the digital image when requested. For the purposes of this disclosure, a segment beginning with an APP marker is called an “APP segment”.

In another example embodiment, a digital photograph may be stored in a file in the Tagged Image File Format (TIFF). The TIFF format is commonly used for storage and exchange of digital images. Images stored in TIFF files can be uncompressed or compressed, but most TIFF files store data in an uncompressed state.

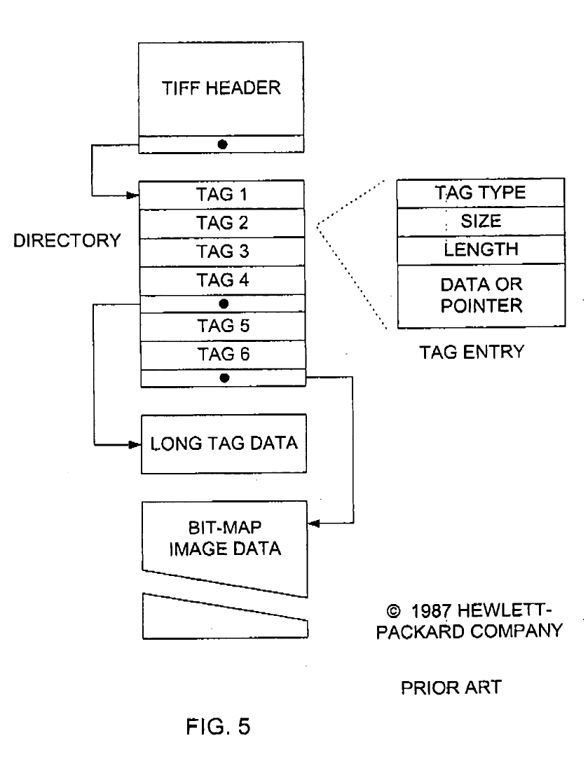

FIG. 5 shows the general structure of a TIFF file, A short file header identifies the file as a TIFF file and provides version information, and supplies a pointer to a directory of tags. Each tag is 12 bytes long, and contains a tag type identifying the image parameter that the tag contains, a size entry indicating the size of each data clement the tag utilizes, a length entry specifying how many data elements are associated with the tag, and a data area that holds the tag data, if the data will fit there. If the tag data do not fit in the data area, then the data area contains a pointer to another location in the file where the data reside. For example, a common tag is the ImageWidth tag, having a structure as is shown in Listing 4. (Data in Listing 4 are shown in “Motorola” format, with the most significant byte of each value first. The TIFF file specification also provides for files to be written in “Intel” format, with bytes in reverse order.)

Listing 4. - TIFF image width tag

| | | | | |
|---|---|---|---|---|
| 01 | 00 | | | tag type 256 (decimal), ImageWidth |
| 00 | 03 | | | indicates data values 16 bits each |
| 00 | 00 | 00 | 01 | indicates only one data value |
| 04 | 00 | xx | xx | image width = 1024 (decimal) |

The data in the last two bytes in the tag are ignored, but space must be reserved in the file to maintain the tag length of 12 bytes.

Many tag types are reserved in the TIFF specification, but it is also possible to select a “private” tag type, In order to avoid conflicting with other private tag types, all private tags should be registered with the administrator of TIFF tags, Adobe Systems, Inc., of San Jose, Calif.

A digital imaging system, such as a camera, in accordance with this second example embodiment of the invention stores the original pixel information in a portion of a TIFF file, using a private tag. Assume, for example, that a tag type of 9876 hexadecimal has been reserved for this purpose. A TIFF tag for storing the data in the table of FIG. 4 may be as follows:

Listing 5. - Private TIFF tag implementation

| | | | | |
|---|---|---|---|---|
| 98 | 76 | | | Private tag number |
| 00 | 03 | | | Tag data values are 2-bytes each |
| 00 | 00 | 00 | 0C | There are 12 data values |
| XX | XX | XX | XX | Pointer to 12 data values |

Because the required 24 bytes of information won't fit in the last 4-byte field of the tag, those bytes hold a pointer to another location in the file, determined at the time the file is written. At that location, the pixel location and data information are presented as follows:

Listing 6. - Data associated with private tag

| | |
|---|---|
| 00 04 00 01 00 80 | 1^{st} pixel X, Y, and original data |
| 00 03 00 02 00 7C | 2^{nd} pixel |
| 00 05 00 02 00 77 | 3^{rd} pixel |
| 00 04 00 03 00 78 | 4^{th} pixel |

A device or software application configured to implement the invention can, upon recognizing the private tag value, locate the original pixel data and replace it in the digital image, thereby undoing the effect of the image adjustment that stored the data. This recovery of the unadjusted digital image is preferably performed with the digital image in an uncompressed state.

While JPEG and TIFF files provide examples of file formats that can be utilized in embodiments of the invention, other formats may be utilized as well.

Because the pixel locations and original pixel data are stored in the file with the digital image, the undoing of the image adjustment need not be performed immediately after the photograph is taken, but can be performed at a later time in the digital camera, or even in another device or system.

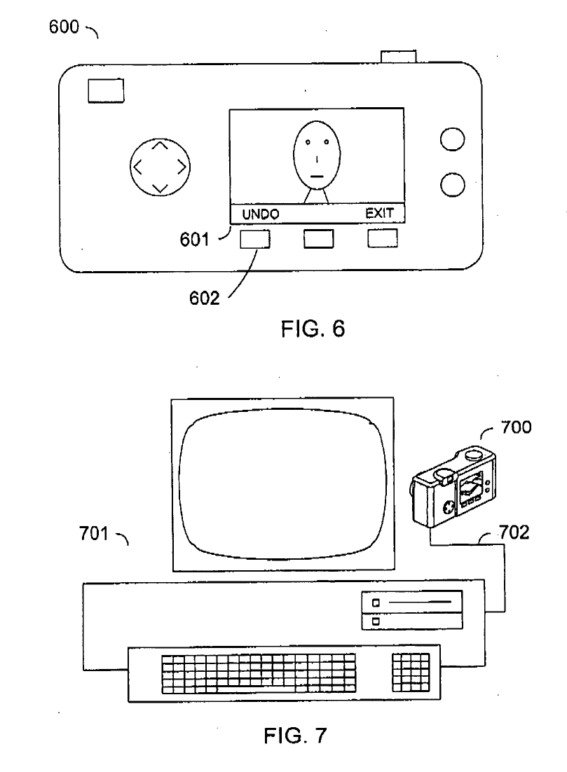

In the event that the undoing is to be performed in a digital camera, the camera will provide a user control that allows the user of the camera to instigate the undoing of the image adjustment. FIG. 6 depicts a user control in accordance with an example embodiment of the invention. With the camera 600 in a mode for reviewing digital photographs, the camera may present the user with an “undo” option in a menu 601. The user may instigate the un-doing by simply pressing the indicated button 602. Of course, other combinations of user controls or menu items are possible within the scope of the appended claims.

In the event that the undoing is to be performed in another device such as a computer, the digital image file is communicated to the other device. This may be accomplished using an interface cable, a wireless link, or by removing a non-volatile storage medium from the camera and placing it where it can be read by the other device. For example, FIG. 7 shows a digital camera 700 connected to a computer 701 using an interface cable 702. Software on the computer 701 can recognize that a transferred digital image file contains original pixel information, and can undo the effect of the corresponding digital image adjustment.

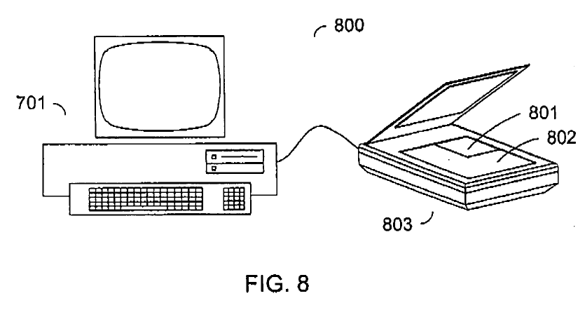

A scanner system provides a second example of a digital imaging system that may embody the invention. FIG. 8 depicts a typical scanning system 800. A scanner 803 produces a digital image of an original item 801 placed on scanner 803. Typically, image information is communicated to an attached computer 701 and stored in a digital image file. Example scanner 803 shown in FIG. 8 is a flatbed scanner, wherein the original item is placed on a flat scanner platen 802, A scanning system may also perform automated image adjustments that generally improve the appearance of a scanned image. For example, a scanning system may apply an automatic exposure adjustment to the scanned image. Some scanner systems provide automatic adjustments that remove certain dispersed high-frequency content from scanned images. This may be desirable because the scanner platen 802 has accumulated dust, or because the original item is scratched, causing sharp, high-frequency defects in the scanned image. The effects of these defects may be minimized with automated processing, sometimes called a “dust and scratches” filter.

Another cause of objectionable high-frequency content in scanned images is image noise caused by electronic noise in the scanner electronics. This can sometimes cause random, isolated pixels in the resulting scanned image to have objectionable, anomalous pixel data. This kind of image noise is sometimes called “speckle”, and may be removed with an image adjustment called a “despeckle” filter.

Occasionally, each of these automatic image adjustments can fail, making the resulting image less pleasing than the original image. For example, the original item may contain certain high-frequency content that is an accurate part of the image on the original, but the automatic adjustment may identify it as speckle, dust, or scratches, and remove the content. If the scanner user does not notice the degradation at the time of scanning, or if the scanner system 800 is operating in an automated mode, the user may have no way to recover the preferred original image.

In a scanner system in accordance with an example embodiment of the invention, the scanner system stores the locations of pixels modified in a digital image and original pixel data from those locations in an informational portion of a digital image file. This original information can be recovered at a later time, and the effect of the automatic image adjustment can be reversed, typically in computer 701 of scanning system 800.

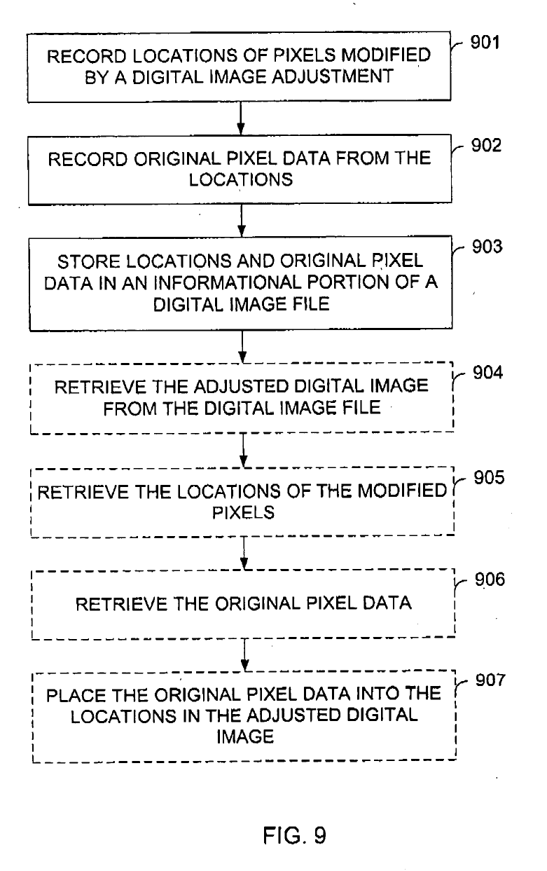

FIG. 9 depicts a flowchart of a method in accordance with an example embodiment of the invention. In step 901, the locations of pixels modified by a digital image adjustment are recorded. In step 902, original pixel data from those locations are recorded. In step 903, the locations and original pixel information are stored in an informational portion of a digital image file. Steps 904 through 907 add the optional recovery of the unadjusted digital image. In step 904, the adjusted digital image is retrieved from the digital image file. In step 905, the locations of the modified pixels are retrieved. In step 906, the original pixel data is retrieved. In step 907, the original pixel data is placed into the digital image.

While the method described may be used to provide for the un-doing of digital image adjustments that affect the entire image, such as an automatic exposure adjustment, it will preferably be used with image adjustments that affect fewer than all of the pixels in a digital image. The example adjustments discussed, redeye-removal, removal of the effects of dust and scratches, and despeckling, provide examples of adjustments that typically affect fewer than all of the pixels in a digital image, but the invention may be employed in conjunction with other image adjustments within the scope of the appended claims.

For example, some digital cameras can optionally imprint the date and/or time a photograph was taken into a digital image by altering some of the pixels in the digital image so that text appears in a corner of the resulting digital photograph. This feature is typically enabled or disabled using a user control. Date/time imprinting is very convenient for record keeping and helps the photographer organize her photos, but may be distracting when a particularly artistic photograph is displayed, such as in a frame. A photographer may inadvertently leave the date/time imprinting feature on while taking photographs that are to be used artistically. In cameras that do not embody the invention, the date/time imprint cannot be removed, so the photographer must either tolerate the distracting text in the photograph or crop the photograph enough to remove the date/time imprint, thereby possibly compromising the composition of the photograph. In a camera or system embodying the invention, the original pixel date overwritten by the date/time imprint can be stored in an informational portion of an image file, allowing the date/time imprint to be removed at a later time. For the purposes of this disclosure, the term “date/time imprint” refers to an imprint of either a date, or a time, or both a date and a time.

The foregoing description of the present invention has been presented for purposes of illustration and description. It is not intended to be exhaustive or to limit the invention to the precise form disclosed, and other modifications and variations may be possible in light of the above teachings. For example, an image adjustment need not have been performed automatically in order for a digital imaging system to apply the invention. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method, comprising the steps of:
a) recording locations of pixels modified in a digital image by a digital image adjustment;
b) recording original pixel data present in the locations before the digital image adjustment; and
c) storing the locations and the original pixel data from the locations in an informational portion of a file comprising the adjusted digital image.

2. The method of claim 1, further comprising the steps of:
a) retrieving, from the file, the adjusted digital image;
b) retrieving, from the file, the locations of pixels modified by the digital image adjustment;
c) retrieving, from the file, the original pixel data present in the locations before the digital image adjustment; and
d) placing the original pixel data into the locations in the adjusted digital image.

3. The method of claim 1, performed in a digital camera.

4. The method of claim 2, performed in a digital camera.

5. The method of claim 1, performed in a scanner system.

6. The method of claim 2, performed in a scanner system.

7. The method of claim 1, wherein the informational portion of the file is a comment segment of a JPEG file.

8. The method of claim 1 wherein the informational portion of the file is tag data in a TIFF file.

9. The method of claim 1 wherein the informational portion of the file is an APP segment in a JPEG file.

10. The method of claim 2 wherein the two recording steps and the storing step are performed in a digital camera, and wherein the three retrieving steps and the placing step are performed in a device other than the digital camera.

11. The method of claim 10 wherein the device other than the digital camera is a computer.

12. The method of claim 1, wherein fewer than all of the pixels in the digital image have been modified by the digital image adjustment.

13. The method of claim 12, where fewer than 5 percent of the pixels in the digital image have been modified by the digital image adjustment.

14. The method of claim 1, wherein the digital image adjustment is redeye removal.

15. The method of claim 1, wherein the digital image adjustment is the removal of dispersed high-frequency content.

16. The method of claim 1, wherein the digital image adjustment is the removal of a date/time imprint.

17. The method of claim 1, wherein the digital image adjustment is performed automatically by a digital imaging system.

18. A digital camera that performs the method of claim 1.

19. A digital camera that performs the method of claim 2.

20. A scanner system that performs the method of claim 1.

21. A scanner system that performs the method of claim 2.

22. A digital camera, comprising:
a) means for producing a digital image;
b) memory that stores the digital image; and
c) logic that performs an adjustment on the digital image, the adjustment modifying pixel data in the digital image;
and wherein the logic records the locations and original content of pixels modified by the adjustment, and stores, in the memory, the locations and original content in an informational portion of a digital image file comprising the adjusted digital image.

23. The camera of claim 22 wherein the logic further retrieves the original content of pixels modified by the adjustment from the informational portion of the digital image file, and replaces the original pixel content into the corresponding locations in the modified digital image, thereby restoring the digital image to its unadjusted state.

24. The camera of claim 23, further comprising a user control that allows a user of the digital camera to instigate the restoration of the digital image to its unadjusted state.
